(19) United States
(12) Patent Application Publication
(10) Pub. No.: US 2012/0154393 A1
(43) Pub. Date: Jun. 21, 2012

(54) APPARATUS AND METHOD FOR CREATING ANIMATION BY CAPTURING MOVEMENTS OF NON-RIGID OBJECTS

(75) Inventors: Ji-Hyung LEE, Daejeon (KR); Bon-Ki Koo, Daejeon (KR); Yoon-Seok Choi, Daejeon (KR); Jeung-Chul Park, Jeonju (KR); Do-Hyung Kim, Daejeon (KR); Bon-Woo Hwang, Daejeon (KR); Kap-Kee Kim, Daejeon (KR); Seong-Jae Lim, Gwangju (KR); Han-Byul Joo, Daejeon (KR); Seung-Uk Yoon, Bucheon (KR)

(73) Assignee: Electronics and Telecommunications Research Institute, Daejeon (KR)

(21) Appl. No.: 13/333,825

(22) Filed: Dec. 21, 2011

(30) Foreign Application Priority Data
Dec. 21, 2010 (KR) 10-2010-0131562

(51) Int. Cl. G06T 13/00; G06T 15/00

(52) U.S. Cl. 345/419

(57) ABSTRACT

Disclosed herein are an apparatus and method for creating animation by capturing the motions of a non-rigid object. The apparatus includes a geometry mesh reconstruction unit, a motion capture unit, and a content creation unit. The geometry mesh reconstruction unit receives moving images captured by a plurality of cameras, and generates a reconstruction mesh set for each frame. The motion capture unit generates mesh graph sets for the reconstruction mesh set and generates motion data, including motion information, using the mesh graph sets. The content creation unit creates three-dimensional (3D) content for a non-rigid object by generating a final transformation mesh set, having a topology similar to that of the reconstruction mesh set, using the motion data.

### CROSS REFERENCE TO RELATED APPLICATION

This application claims the benefit of Korean Patent Application No. 10-2010-0131562, filed Dec. 21, 2010, which is hereby incorporated by reference in its entirety into this application.

### BACKGROUND OF THE INVENTION

1. Technical Field

The present invention relates generally to an apparatus and a method for creating animation by capturing movement of a non-rigid object and, more particularly, to an apparatus and a method for creating three-dimensional (3D) content animation by capturing movement of a non-rigid object.

2. Description of the Related Art

The recent rapid increase in 3D content has been accompanied by an increasing interest in 3D animation that represents motions similar to those of the real world. Accordingly, there is also an increasing interest in motion capture technology for creating 3D content animation in real time from motions of the real world.

Motion capture technology is chiefly used to capture the body actions of humans, and is gradually coming to be used to capture the motions of animals. Furthermore, performance capture technology for capturing facial expressions as well as body motions is widely used at places where high-quality 3D content is produced.

Since motion capture technology is configured such that a specific number of markers are attached to a person and the movement of the person is captured by tracking the markers, the subject of capture must be a rigid object. Here, the “rigid object” refers to an object that has a fixed shape that does not change, and what is captured in motion caption is not changes in shape but just changes in positions, directions and others such the movement of its joints.

Accordingly, conventional motion capture technologies have problems in that it is difficult to accurately reflect movements of the real world because they cannot capture the movements of non-rigid objects having varying shapes and in that a lot of expenses and a long production period are required because manual work is used to produce the content.

### SUMMARY OF THE INVENTION

Accordingly, the present invention has been made keeping in mind the above problems occurring in the prior art, and an object of the present invention is to provide an apparatus and a method for creating 3D content animation by capturing the movements of a non-rigid object.

In order to accomplish the above object, the present invention provides an animation creation apparatus, including a geometry mesh reconstruction unit for receiving moving images captured by a plurality of cameras, and generating a reconstruction mesh set for each frame; a motion capture unit for generating mesh graph sets for the reconstruction mesh set and generating motion data, including motion information, using the mesh graph sets; and a content creation unit for creating 3D content for a non-rigid object by generating a final transformation mesh set, having a topology similar to that of the reconstruction mesh set, using the motion data.

The motion capture unit may include a mesh graph generation unit for receiving the reconstruction mesh set and generating mesh graph sets wherein the number of mesh graph sets is equal to the number of meshes of the reconstruction mesh set.

The motion capture unit may include a transformation information processing unit for generating mesh-graph transformation information by expressing an Affine transformation of the mesh graph sets as a matrix.

The motion capture unit may obtain the difference between an i-th mesh graph and an (i+1)-th mesh graph using the mesh-graph transformation information, generate temporal coherence information based on the difference, and generate the motion data based on the temporal coherence information.

The content creation unit may include a primitive detection unit for searching for a primitive mesh and a primitive mesh graph which are most similar to the reconstruction mesh set.

The content creation unit may include a mesh transformation unit for generating transformation mesh graph sets by applying the motion data to the primitive mesh graph, and generating transformation mesh sets corresponding to the transformation mesh graph sets.

The content creation unit may further include an animation mesh generation unit for generating a final mesh set by comparing the transformation mesh set with the reconstruction mesh set, and generating the final transformation mesh set using a coherence map between the final mesh set and the reconstruction mesh set.

The animation mesh generation unit may generate an animation mesh by setting a value, transformed according to animation, in the final transformation mesh set as an animation key, and generate the 3D content for the non-rigid object using the animation mesh.

The animation creation apparatus may further include a mesh data storage unit for storing the primitive mesh and the primitive mesh graph generated by processing the primitive mesh.

Additionally, in order to accomplish the above object, the present invention provides an animation creation method, including receiving moving images captured by a plurality of cameras and generating a reconstruction mesh set for each frame; generating mesh graph sets for the reconstruction mesh set; generating motion data, including motion information, using the mesh graph sets; generating a final transformation mesh set having a topology similar to that of the reconstruction mesh set using the motion data; and creating 3D content for a non-rigid object using the final transformation mesh set.

The generating the motion data may include generating mesh-graph transformation information by expressing an Affine transformation of the mesh graph sets as a matrix; obtaining a difference between an i-th mesh graph and an (i+1)-th mesh graph using the mesh-graph transformation information; and generating temporal coherence information based on the difference, and generating the motion data based on the temporal coherence information.

The generating the final transformation mesh set may include searching for a primitive mesh and a primitive mesh graph most similar to the reconstruction mesh set; generating transformation mesh graph sets by applying the motion data to the primitive mesh graph; generating transformation mesh sets corresponding to the transformation mesh graph sets; generating a final mesh set by comparing the transformation mesh set with the reconstruction mesh set; and generating the final transformation mesh set using a coherence map between the final mesh set and the reconstruction mesh set.

The creating 3D content may include generating an animation mesh by setting a value, transformed according to animation, in the final transformation mesh set as an animation key; and generating the 3D content for the non-rigid object using the animation mesh.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an animation creation apparatus according to an embodiment of the present invention;

FIG. 2 is a diagram showing an example of a mesh set according to an embodiment of the present invention;

FIG. 3 is a diagram schematically showing the motion capture unit of FIG. 1;

FIG. 4 is a diagram showing an example of mesh graphs according to an embodiment of the present invention;

FIG. 5 is a diagram schematically showing the content creation unit of FIG. 1; and

FIG. 6 is a flowchart illustrating a process by which the animation creation apparatus of FIG. 1 creates 3D content.

### DESCRIPTION OF THE PREFERRED EMBODIMENTS

Reference now should be made to the drawings throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

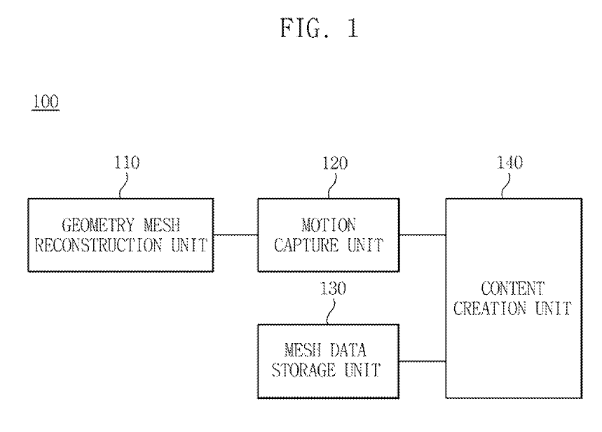

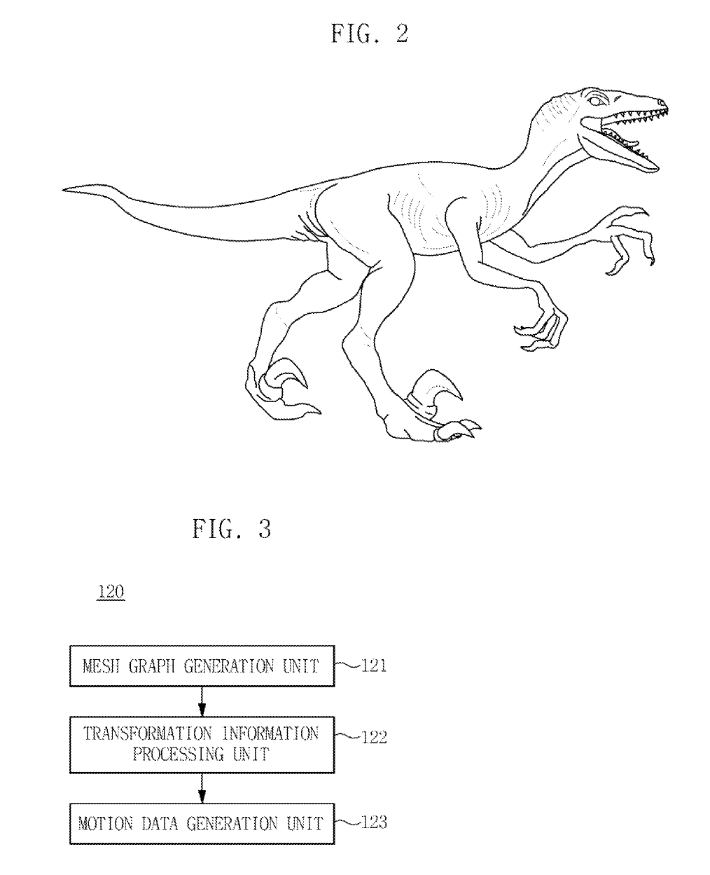

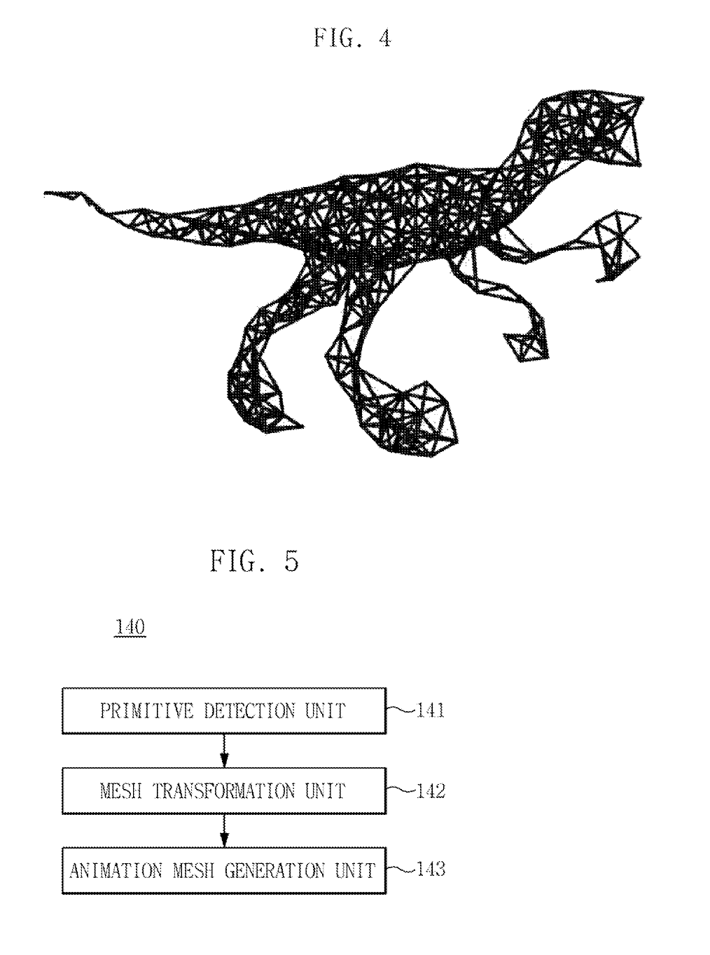

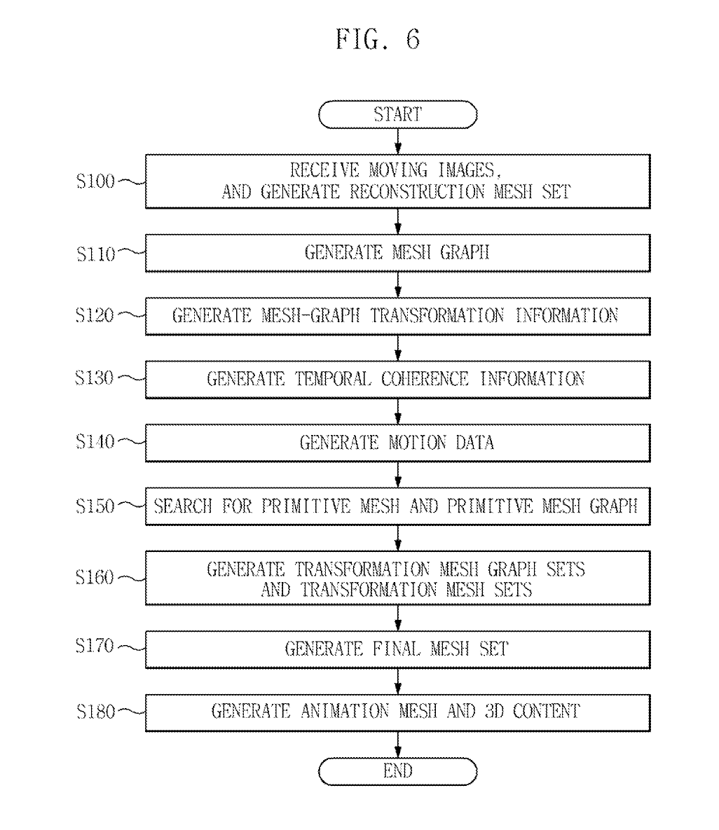

FIG. 1 is a diagram schematically showing an animation creation apparatus according to an embodiment of the present invention. FIG. 2 is a diagram showing an example of a mesh set according to an embodiment of the present invention. FIG. 3 is a diagram schematically showing the motion capture unit of FIG. 1. FIG. 4 is a diagram showing an example of mesh graphs according to an embodiment of the present invention. FIG. 5 is a diagram schematically showing the content creation unit of FIG. 1.

As shown in FIG. 1, the animation creation apparatus 100 for creating animation by capturing the motions of a non-rigid object according to one embodiment of the present invention includes a geometry mesh reconstruction unit 110, a motion capture unit 120, a mesh data storage unit 130, and a content creation unit 140.

The geometry mesh reconstruction unit 110 receives moving images captured by a plurality of moving image cameras (not shown). The geometry mesh reconstruction unit 110 generates a reconstruction mesh set by restoring geometry meshes for each of the consecutive frames of the moving images. Reconstruction mesh sets equal to the number of frames are reconstructed according to an embodiment of the present invention, and an example of a mesh is shown in FIG. 2.

The motion capture unit 120 generates motion data by generating mesh graph sets for the reconstruction mesh set. As shown in FIG. 3, the motion capture unit 120 includes a mesh graph generation unit 121, a transformation information processing unit 122, and a motion data generation unit 123.

The mesh graph generation unit 121 receives the reconstruction mesh set from the geometry mesh reconstruction unit 110. Furthermore, the mesh graph generation unit 121 generates mesh graph sets equal to the number of meshes of the reconstruction mesh set. Here, a mesh set only contains surface information, whereas a mesh graph refers to affine transformation for a mesh which is defined in the form of a graph in order to more conveniently deal with the transformation of a mesh. A mesh graph is a model that is simplified to include spatial and structural information while maintaining the shape of the mesh, as shown in FIG. 4.

The transformation information processing unit 122 receives mesh graph sets equal to the number of meshes of the reconstruction mesh set from the mesh graph generation unit 121. Since common spatial transformation is defined as in Equation 1, the transformation information processing unit 122 generates mesh-graph transformation information by expressing an affine transformation Q in the form of a 3×3 matrix as shown in Equation 2.

Qvᵢ+d=\tilde{v}ᵢ (1)

Q=\tilde{V}V⁻¹ (2)

In Equation 1, d is a displacement vector, and i is each vertex of a mesh graph.

The motion data generation unit 123 receives transformation information among the mesh-graph sets from the transformation information processing unit 122. The motion data generation unit 123 obtains the difference between a first mesh graph and a second mesh graph along the time axis by comparing the first mesh graph with the second mesh graph based on mesh-graph transformation information because the mesh graph sets are generated to correspond to the reconstruction mesh set for each frame of the moving image and are arranged in time sequence. Furthermore, the motion data generation unit 123 obtains the difference between the second mesh graph and a third mesh graph by comparing the second mesh graph with the third mesh graph. The motion data generation unit 123 generates temporal coherence information [Di(v)] by obtaining the differences between the mesh graphs up to the last mesh graph by repeating the above process. The temporal coherence information [Di(v)] is expressed by the following Equation 3:

$${D}_{i} ( v ) = {\sum }_{i = 1}^{x} ( {G}_{i} - {G}_{i + 1} ) \qquad ( 3 )$$

In other words, assuming that each mesh graph set includes X mesh graphs and each mesh graph has N graph nodes, the motion data generation unit 123 defines the temporal coherence information [Di(v)] depending on the difference between an i-th mesh graph G, and an (i+1)-th mesh graph Gᵢ₊₁.

Furthermore, the motion data generation unit 123 may obtain information about the degree of difference between the first and last mesh graphs of the first one of the mesh graph sets based on the temporal coherence information [Di(v)], and generates motion data including motion information based on the difference.

Referring back to FIG. 1, the mesh data storage unit 130 stores various types of primitive meshes and primitive mesh graphs derived by the primitive meshes. In order to apply motion data according to the embodiment of the present invention to another mesh, the motion data should have a topology similar to that of a reconstruction mesh set. Accordingly, the mesh data storage unit 130 stores various types of primitive meshes and primitive mesh graphs, which were generated in advance.

The content creation unit 140 generates meshes including animation (hereinafter referred to as “animation meshes”) using the motion data received from the motion capture unit 120, and generates 3D content using the meshes. The content creation unit 140 includes a primitive detection unit 141, a mesh transformation unit 142, and an animation mesh generation unit 143, as shown in FIG. 5.

The primitive detection unit 141 receives the motion data from the motion capture unit 120. The primitive detection unit 141 searches the mesh data storage unit 130 for a primitive mesh and a primitive mesh graph most similar to the reconstruction mesh set, and selects target meshes to be applied to the motion data.

The mesh transformation unit 142 generates transformed mesh graph sets (hereinafter “transformation mesh graph sets”) by applying the motion data to the primitive mesh graph which has been selected for each frame in the motion data. Furthermore, the mesh transformation unit 142 generates transformed mesh sets (hereinafter “transformation mesh sets”) corresponding to the transformation mesh graph sets.

The animation mesh generation unit 143 receives the transformation mesh graph sets and the transformation mesh sets from the mesh transformation unit 142. The animation mesh generation unit 143 generates a finally transformed mesh set (hereinafter “final mesh set”) by comparing the transformation mesh set with the reconstruction mesh set for each frame.

Furthermore, the number of vertices constructing each mesh in the reconstruction mesh set is different from the number of vertices constructing each mesh in the final mesh set because the reconstruction mesh set and the final mesh set have similar topologies but do not have the same topology. Therefore, the animation mesh generation unit 143 performs coherence map work so as to associate the reconstruction mesh set with the final mesh set.

For example, assuming that the reconstruction mesh set includes X vertices and the final mesh set to be compared with the reconstruction mesh set includes Y vertices, the animation mesh generation unit 143 generates a final transformation mesh set by defining a coherence map M between these two mesh sets using the following Equation 4:

Mi={(s₁,t₁),(s₂,t₂),(s_{|X|},t_{|Y|})} (4)

Here, the reconstruction and transformation mesh sets have a similar topology and thus include the same N meshes. A coherence forming the reconstruction mesh set “s” and a coherence forming the transformation mesh set “t” are defined in the coherence map Mi. Accordingly, the final transformation mesh set has the same structure and topology because it has been transformed and generated from the same primitive mesh.

The animation mesh generation unit 143 generates the animation meshes by setting a value, transformed according to animation, as an animation key in the final transformation mesh set. The animation meshes according to an embodiment of the present invention have the same structure as meshes including animation produced by the manual work in a conventional graphic tool, and can be used to produce 3D content without any change. The animation mesh generation unit 143 creates 3D content for a non-rigid object using the animation meshes.

FIG. 6 is a flowchart illustrating a process by which the animation creation apparatus of FIG. 1 creates 3D content.

As shown in FIG. 6, the geometry mesh reconstruction unit 110 of the animation creation apparatus 100 according to one embodiment of the present invention receives moving images captured by a plurality of moving image cameras (not shown). Furthermore, the geometry mesh reconstruction unit 110 generates a reconstruction mesh set by restoring geometry meshes for each frame at step S100.

The motion capture unit 120 generates mesh graph sets for the reconstruction mesh set using the reconstruction mesh set at step S110. The motion capture unit 120 generates mesh-graph transformation information about the mesh graph sets at step S120. The motion capture unit 120 generates temporal coherence information based on the difference between an i-th mesh graph Gᵢ and an (i+1)-th mesh graph Gᵢ₊₁ based on the mesh-graph transformation information at step S130. The motion capture unit 120 generates motion data based on the temporal coherence information at step S140.

The content creation unit 140 receives the motion data from the motion capture unit 120. Furthermore, the content creation unit 140 searches the mesh data storage unit 130 for a primitive mesh and a primitive mesh graph which are most similar to the reconstruction mesh set at step S150. The content creation unit 140 generates transformation mesh graph sets by applying the motion data to the primitive mesh graph and generates transformation mesh sets corresponding to the transformation mesh graph sets at step S160. The content creation unit 140 generates a final mesh set by comparing the transformation mesh set with the reconstruction mesh set at step S170. The content creation unit 140 generates an animation mesh by setting a value, varying depending on animation, in the final mesh set as an animation key and creates 3D content using the animation mesh at step S180.

As described above, the animation creation apparatus according to the embodiment of the present invention generates mesh graphs using moving images, and creates 3D content for a non-rigid object using the mesh graphs. Accordingly, the production period can be reduced, and animation for a non-rigid object, producing the sensation of being real, can be created, compared to content created manually.

Furthermore, the animation for a non-rigid object, which has conventionally been created manually, can be created by capturing the motions of the non-rigid object in the real world. Accordingly, the animation for a non-rigid object can be created more quickly, and the manufacturing cost thereof can be reduced.

Furthermore, the present invention may be applied to not only the production of animation, but also the production of high-quality image content used in 3D technology and a variety of their application fields.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An animation creation apparatus for creating three-dimensional (3D) content for a non-rigid object, comprising
a geometry mesh reconstruction unit for receiving moving images of a non-rigid object captured by a plurality of cameras, and generating a reconstruction mesh set for each frame;
a motion capture unit for generating mesh graph sets for the reconstruction mesh set and generating motion data, including motion information, using the mesh graph sets; and
a content creation unit for creating 3D content for the non-rigid object by generating a final transformation mesh set, having a topology similar to that of the reconstruction mesh set, using the motion data.

2. The animation creation apparatus as set forth in claim 1, wherein the motion capture unit comprises a mesh graph generation unit that are configured to receive the reconstruction mesh set and generate mesh graph sets, wherein the number of the generated mesh graph sets is equal to the number of meshes of the reconstruction mesh set.

3. The animation creation apparatus as set forth in claim 2, wherein the motion capture unit further comprises a transformation information processing unit for generating mesh-graph transformation information by expressing an Affine transformation of the mesh graph sets as a matrix.

4. The animation creation apparatus as set forth in claim 3, wherein the motion capture unit obtains a difference between an i-th mesh graph and an (i+1)-th mesh graph using the mesh-graph transformation information, generates temporal coherence information based on the difference, and generates the motion data based on the temporal coherence information.

5. The animation creation apparatus as set forth in claim 1, wherein the content creation unit comprises a primitive detection unit for searching for a primitive mesh and a primitive mesh graph which are most similar to the reconstruction mesh set.

6. The animation creation apparatus as set forth in claim 5, wherein the content creation unit further comprises a mesh transformation unit for generating transformation mesh graph sets by applying the motion data to the primitive mesh graph, and generating transformation mesh sets corresponding to the transformation mesh graph sets.

7. The animation creation apparatus as set forth in claim 6, wherein the content creation unit further comprises an animation mesh generation unit for generating a final mesh set by comparing the transformation mesh set with the reconstruction mesh set, and generating the final transformation mesh set using a coherence map between the final mesh set and the reconstruction mesh set.

8. The animation creation apparatus as set forth in claim 7, wherein the animation mesh generation unit generates an animation mesh by setting, in the final transformation mesh set, a value, which is transformed according to animation, as an animation key and generates the 3D content for the non-rigid object using the animation mesh.

9. The animation creation apparatus as set forth in claim 5, further comprising a mesh data storage unit for storing the primitive mesh and the primitive mesh graph generated by processing the primitive mesh.

10. An animation creation method for creating three-dimensional (3D) content for a non-rigid object, comprising
receiving moving images of a non-rigid object, captured by a plurality of cameras and generating a reconstruction mesh set for each frame;
generating mesh graph sets for the reconstruction mesh set;
generating motion data, including motion information, using the mesh graph sets;
generating a final transformation mesh set having a topology similar to that of the reconstruction mesh set using the motion data; and
creating 3D content for the non-rigid object using the final transformation mesh set.

11. The animation creation method as set forth in claim 10, wherein the generating the motion data comprises:
generating mesh-graph transformation information by expressing an Affine transformation of the mesh graph sets as a matrix;
obtaining a difference between an i-th mesh graph and an (i+1)-th mesh graph using the mesh-graph transformation information; and
generating temporal coherence information based on the difference, and generating the motion data based on the temporal coherence information.

12. The animation creation method as set forth in claim 10, wherein the generating the final transformation mesh set comprises:
searching for a primitive mesh and a primitive mesh graph most similar to the reconstruction mesh set;
generating transformation mesh graph sets by applying the motion data to the primitive mesh graph;
generating transformation mesh sets corresponding to the transformation mesh graph sets;
generating a final mesh set by comparing the transformation mesh set with the reconstruction mesh set; and
generating the final transformation mesh set using a coherence map between the final mesh set and the reconstruction mesh set.

13. The animation creation method as set forth in claim 12, wherein the creating 3D content comprises:
generating an animation mesh by setting, in the final transformation mesh set, a value, which is transformed according to animation, as an animation key; and
generating the 3D content for the non-rigid object using the animation mesh.
